(19) United States
(12) Patent Application Publication
(10) Pub. No.: US 2017/0187577 A1
(43) Pub. Date: Jun. 29, 2017

(54) SYSTEM FOR CONFIGURING NETWORK DEVICES

(71) Applicants: Tejas Subhash Nevrekar, Bangalore (IN); Iyappa Swaminathan BJ, Bangalore (IN); Sridhararao Kothe, Bangalore (IN)

(72) Inventors: Tejas Subhash Nevrekar, Bangalore (IN); Iyappa Swaminathan BJ, Bangalore (IN); Sridhararao Kothe, Bangalore (IN)

(73) Assignee: Nuviso Networks Inc, Milpitas, CA (US)

(21) Appl. No.: 15/458,032

(22) Filed: Mar. 14, 2017

(51) Int. Cl. H04L 12/24

(52) U.S. Cl. CPC H04L 41/0843; H04L 41/22

(57) ABSTRACT

An embodiment provides a system for configuring network devices. The system includes a database, wherein the database further includes a set of models and a plurality of translator files. The system further includes one or more processors. The set of models represent/define plurality of network level or device level features as per YANG models, wherein one model corresponds to one device or network level feature in a way agnostic to device manufacturer or device families. A translator file among the plurality of translator files is executed by the processor to convert an instruction, as represented by the set of models, into network or device specific instructions in a second format.

### BACKGROUND

Unless otherwise indicated herein, the materials described in this section are not prior art to the claims in this application and are not admitted to be prior art by inclusion in this section.

Field

The subject matter in general relates to computer networks. More particularly, the subject matter relates to configuring network elements of diverse types and configurations.

Discussion of Related Art

A computer network is set up by connecting computers and peripherals using network devices. Network devices such as, switches and routers enable devices, connected to a network, to communicate with each other by way of sharing application servers, storage servers, sharing printers and fax machines, sharing files, and sharing internet connection, among others. For instance, one or more computers can connect to printers, fax machines, scanners, and servers through network switches. Further, routers enable a local network to connect to other local networks, thereby enabling devices that are connected to a network to communicate with other networks as well.

Setting up a computer network requires configuring different network devices such that they enable communication between computers and peripherals within the network. Conventionally, to configure network devices, a user enters commands/instructions via a user interface on a user's computer.

Different network devices (switches and network routers) are manufactured by different manufacturers. Further, switches and routers may have different configurable features. In conventional methods, to configure such diverse network devices, the user device's CLI requires a network administrator or a user to provide/write custom codes or programs specific to each network device based on their type and make. Further, each network device that may have a different set of configurable features, require different set of commands to be written on the CLI. Hence, for someone to write the custom codes specific to the network device type and make, he/she must understand the type of device and at the same time have knowledge on writing codes.

Presently, Yang data model is becoming the data model of choice amongst most networking enterprises and service providers who deploy large set of networking equipment. YANG data model defines the schema for device configuration and state. In addition to device specific data models, YANG may be used to create a data model agnostic of device type and manufacturer variations.

Yang models are driven by NETCONF configuration protocol, which provides native support for Yang data model. Hence, for an end user's device to be able to normalize network configurations using Yang data model, the device should also support NETCONF protocol. However, most of the network devices may not provide support for NETCONF protocol in their gear.

Therefore, in light of the foregoing discussion, a generic solution that employs a vendor agnostic data model to enable configuration of network devices through a single interface, regardless of their type and manufacture, is required.

### SUMMARY

An embodiment provides a system for configuring network devices. The system includes a database, wherein the database further includes a set of models and a plurality of translator files. The system further includes one or more processors. The set of models represent/define plurality of network level or device level features as per YANG models, wherein one model corresponds to one device or network level feature in a way agnostic to device manufacturer or device families. A translator file among the plurality of translator files is executed by the processor to convert an instruction, as represented by the set of models, into network or device specific instructions in a second format.

### BRIEF DESCRIPTION OF THE DRAWINGS

Embodiments are illustrated by way of example and not limitation in the Figures of the accompanying drawings, in which like references indicate similar elements and in which:

FIG. 1 is a block diagram of an exemplary system comprising a processor 103 and a database 100 including set of models 102 and translator files 104 for configuring network devices and networks and receiving status of network devices;

FIG. 2 is a block diagram of the system of FIG. 1 further comprising a user's device sending instructions in a standardized format defined by YANG model for configuring a network/network device;

FIG. 3 is an illustration of the exemplary set of models 102 and the corresponding translator files 104 for one or more configurable features of a particular device;

FIG. 4 is a flowchart illustrating a method of converting instructions based on a standardized model into device specific instructions; and

FIG. 5 is a flowchart illustrating a method for converting status information corresponding to the feature of a network or a network device, to a standardized format, as defined by the YANG model.

### DETAILED DESCRIPTION

### I. Overview

### II. System for Configuring Network Devices or Networks

### III. Conclusion

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a system for enabling configuration of network device or network level features. Embodiments further describe receiving status information corresponding to device level features or network level features. The system includes a database which further includes a set of models and a plurality of translator files. The system further includes one or more processors. The set of models are, for example, YANG data models. The set of models may be a plurality of files which include containers to store information corresponding to configurable device level or network level features. Each configurable feature belonging to a network or a network device may correspond to at least one translator file among the translator files. Each translator file includes information relating to at least one feature corresponding to one device or a network. Instructions are received, from an end user's device, indicating a feature to be configured. The instructions specify at least a path that includes an identifier. The identifier indicates a particular device instance. The path leads to a container in at least one model among the set of models where the information corresponding to the device and the feature is stored. The processor executes a translator file to convert the instruction, as defined by the set of models, into network or device specific instructions. For each model among the set of models, there is at least one translator file among the plurality of translator files. Each configurable feature corresponding to a network or a network device may be included in one file among the translator files.

Additionally, the translator files enable conversion of status related information corresponding to network elements, from network element specific format to a format that is compliant with the YANG data model. As an example, a translator file processes device specific output received from a network device indicating status of the device. The output, which is in the network device specific format may include data indicating status of the network device. Translator files are configured to parse the output from the device and convert the output to the format as defined by the set of models. Further, the translator files map the parsed information to a relevant model among the set of models.

### II. Overview of Yang Data Model

YANG data modeling language is designed to write data models for the NETCONF protocol. NETCONF is the network management protocol that provides a secure platform to an administrator or network engineer to configure a, router, switch, firewall or other network devices. NETCONF protocol defines a mechanism through which a network device can be managed, configuration data information can be retrieved, and new configuration data can be applied.

The NETCONF protocol uses XML based data encoding for the configuration data. NETCONF facilitates communication between a client and a server. The client can be a script or application typically running as part of a network manager. The server is typically a network device.

Together, NETCONF and YANG provide tools that network administrators need to automate configuration tasks across heterogeneous devices in a network. YANG data modeling language provides descriptions of a network's nodes and their interactions. Each YANG module defines a hierarchy of data that can be used for NETCONF based operations, including configuration and state data.

YANG model provides the following features—human readable, easy to learn, hierarchical configuration data models, reusable types, and groupings (structured types), data modularity through modules and sub-modules, leaf, leaf-list, container, and built-in data types, among others. Yang may be encoded into JSON and YANG definitions directly map on to NETCONF' s (XML) content.

A unique module that maps with the YANG data model, for devices that do not provide native support for NETCONF protocol, is provided in the subsequent sections of this description.

### III. System for Configuring Network Devices or Networks

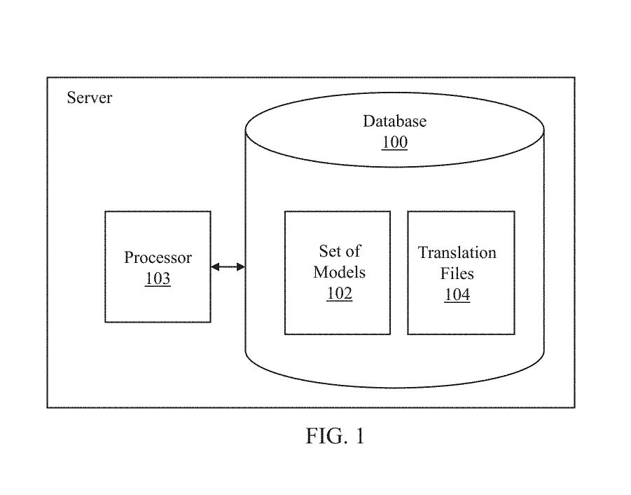

In an embodiment, a system for enabling configuration of network devices and receiving status information of network devices is provided. One or more embodiments may provide a system for enabling configuration of networks and receiving status information of networks. Referring to FIG. 1 the system includes a database 100. The database 100 includes a set of models 102 and a plurality of translator files 104. The system may further include one or more processors 103.

The database 100 may be deployed on a cloud server. The server is configured with processing, memory, and storage capacity to handle the load of data and program instructions as well as data generated during the execution of these programs.

In an embodiment, the set of models 102 may be a plurality of files. A model among the set of models 102 defines configurable features of network devices or networks in a hierarchical fashion. Each hierarchical level of the file may include one or more containers to store information corresponding to a feature. The set of models 102 includes containers to store information corresponding to features of a network device. Each configurable feature belonging to a network or a network device may correspond to at least one translator file among the translator files 104.

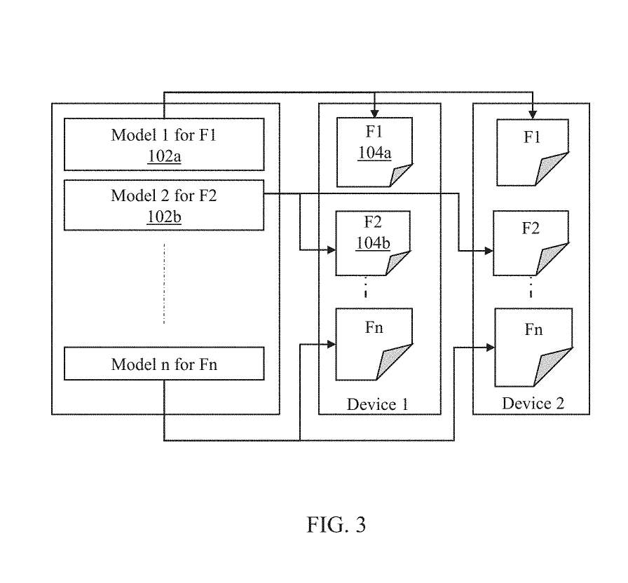

The set of models 102 are, for example, YANG data models. Referring to FIG. 3, each YANG model 102a may correspond to at least one translator 104a among the translator files 104. In other words, one translator file is relevant to at least one model among the set of models 102.

Further, each translator file includes information relating to at least one feature corresponding to one device or a network. Some translator files may include information relating to one feature corresponding to multiple devices of similar type and make. Information corresponding to the compliant or relevant model is indicated by the instruction generated at a user's device. The system determines the relevant translator file to be used for configuration of a feature based on the identification of the model among the set of models 102. The model is identified based on the instruction received from an end user's device.

In an embodiment, the instructions received from the end user's device 200 may be processed to extract data fields. Instructions may include a path that identifies device/network level feature to be configured. The path includes an identifier configured to identify a specific device instance belonging to a particular type. Instructions may further include payload information that includes information using which a feature may be configured.

In an embodiment, the instructions may be validated by the processor 103 to determine if the instructions conform with a relevant YANG model. In other words, the validation is required to check if each data field in the instruction conforms with a format as defined by the set of models 102. As an example, the payload instruction may be checked to see if the data corresponding to the field “mtu” is a number. The validation may be carried out by the processor 103.

The processor 103 may further extract or parse the instruction comprising the path. The extracted path information may be used to identify the relevant translator file among the translator files 104 based on the type of the device derived from the device identifier (id) included in the path. Further, the processor 103 extracts the data fields from the payload instructions. Upon identifying the specific/relevant translator file, the processor 103 executes the identified translator file to convert the extracted data fields (payload) as defined by the YANG model into device specific instructions.

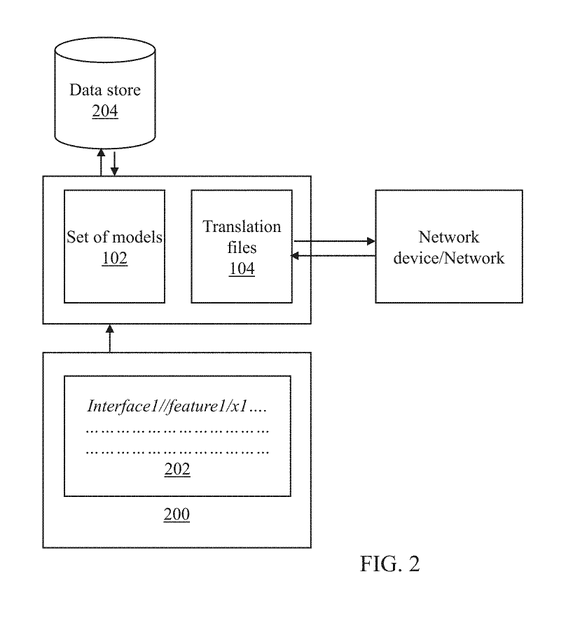

Referring to FIG. 2, a block diagram illustrates the system configured to receive instructions/commands/inputs from an end user's device 200. The user device 200 is a computer including a CL interface 202, a processor, memory units and a communication module, among other components.

The CL interface 202 of the user device 200 receives commands and/or instructions that is required for configuring one or more features (for example interface ports) of a network device or a network. The command may be received in a format that is defined by the set of models 102. The command/instruction is specific to the category of device or network. Category of device may include devices with different configurable features such as interface vlans, vpns, and routing protocols like bgp, ospf, among others, regardless of the manufacturing entity. The command complies with at least one model among the set of models 102.

In an embodiment, the commands or instructions specify at least a path that includes an identifier. The identifier identifies a specific device instance belonging to a particular type. Type of device, as an example, is a derivative of the manufacturer (Cisco, Juniper), class (router/switch), device family (IOS-XR, IOS-XE, JunOS), version (12.0, 11.0). The path leads to a container in at least one model among the set of models 102 where the information corresponding to the device and the feature is stored.

The path may refer to a feature, which may be an interface of a network device. An example of the instruction that specifies the path corresponding to a feature (interface) may be as provided below,

“http://{{host}}/network/configuration/devices/{{deviceId}}/openconfig-
interfaces@2016-05-26/interfaces/interface/BDI2252”;

In an embodiment, the commands or instructions may further include at least pay load information associated with the configurable feature. The pay load information may include, for example, a parameter or a value, known to an end user, using which the feature is to be configured. In an example, the payload information may be provided as follows,

```
Payload data:
{
  “config”: {
    “mtu”: “1500”,
    “name”: “BDI2252”,
    “enabled”: “true”
  }
}
Initial mapping from the yang path:
    “declarations”:[
          {
            “operation”:“container”,
            “ypath”:“/openconfig-interfaces@2016-05-
26/interfaces/interface”,
            “yname”:“${interface}”,
            “yid”:“name”
          },
          {
            “operation”:“container”,
            “ypath”:“{interface}/config”,
            “yname”:“${interface-config}”
          },
Translator files: Parsing input and identifying model
          {
            “pre-processors”:[
              {
                “field”:“$finterfacefname”,
                “Parse-instruction-type”:“validator”,
                “match-regex”:“(.*)”,
                “match-groups”:“${ifName}”,
                “mandatory”:true
              }
            ],
            “commands”:[
              {
                “command-id”: “CMD_INTERFACE_CREATE”,
                “command-name”:“interface ${ifName}”,
                “parser-ref”:“PARSE_ERROR_HANDLER_DEFAULT”
              },
              {
                “command-id”: “CMD_INTERFACE_CDP_ENABLE”,
                “command-name”:“${cdp_var}”,
                “parser-ref”:“PARSE_ERROR_HANDLER_DEFAULT”
              }
            ]
          },
          {
            “pre-processors”:[
              {
                “field”:“$finterface-configfmtu”,
                “Parse-instruction-type”:“validator”,
                “match-regex”:“(*)”,
                “match-groups”:“${ifMtu}”
              }
            ]
            “commands”:[
              {
                “command-id”:“CMD_INTERFACE_MTU”,
                “command-name”:“mtu ${ifMtu}”,
                “parser-ref”:“PARSE_ERROR_HANDLER_DEFAULT”
              }
            ]
          },
Translator file: Issuing command to get interface data from the device
    {
      “command-id”:“SHOW_INTERFACES”,
      “command-name”:“show interfaces”,
Translator files: Reading output of the command
                  {
                    “parse-instruction-type”:“regex”,
                    “match-
regex”:“.*MTU\\s+ (\\d+)\\s+ bytes, \\s+ BW\\s+ (\\d+)\\s+ Kbit\\/sec, \\s+ DLY
\\s+(\\d+)\\s+usec,. *”,
                    “match-groups”:“${mtu}, ${bandwidth} , ${delay}”
                  },
Translator files: Mapping the output to the relevant model
                  {
                    “Parse-instruction-type”:“event”,
                    “event-type”:“POST_BLOCK_EVENT”,
                    “match-operations”:[
                      {
                        “operation”:“container”,
                      “ypath”:“/openconfig-interfaces@2016-05-
26/interfaces/interface/<interface:name>”,
                        “yname”:“${component}”,
                        “yid”:“name”
                      },
                      {
                        “operation”:“container”,
                        “ypath”:“{component}/oc-eth:ethernet/oc-eth:state”,
                        “yname”:“${component-ethernet}”
                      },
                      {
                        “operation”:“container”,
                        “ypath”:“${component}/config”,
                        “yname”:“${component-config}”
                      },
                      {
                        “operation”:“container
                        “ypath”:“${component}/state”,
                        “yname”:“${component-state}”
                      },
Translator files: Setting value for output in the set of models:
                      {
                        “operation”:“set-value
                        “ypath”:“${component-state}. mtu”,
                        “value”:“${mtu}”
                      }
```

In the above example, the payload information indicates that the “mtu” (maximum transmission unit) of an interface port should be set to 1500 and the interface name is “BDI2252”. A YANG model among the set of models 102 and a corresponding translator file is identified from the path. The type of device is identified from the identifier. Further, the payload information provides information on how to configure the feature of a network device or a network.

The system may include a datastore 204. The data store 204 may be deployed on cloud server. The set of models 102 may be connected to the data store 204. Datastore 204 stores instances of status information corresponding to a network or network device defined by the set of models 102. Data store 204 may include containers, list items and leaf values. In an embodiment, the user device 200 may access the data store 204 to query instructions corresponding to a feature as defined by the set of model 102.

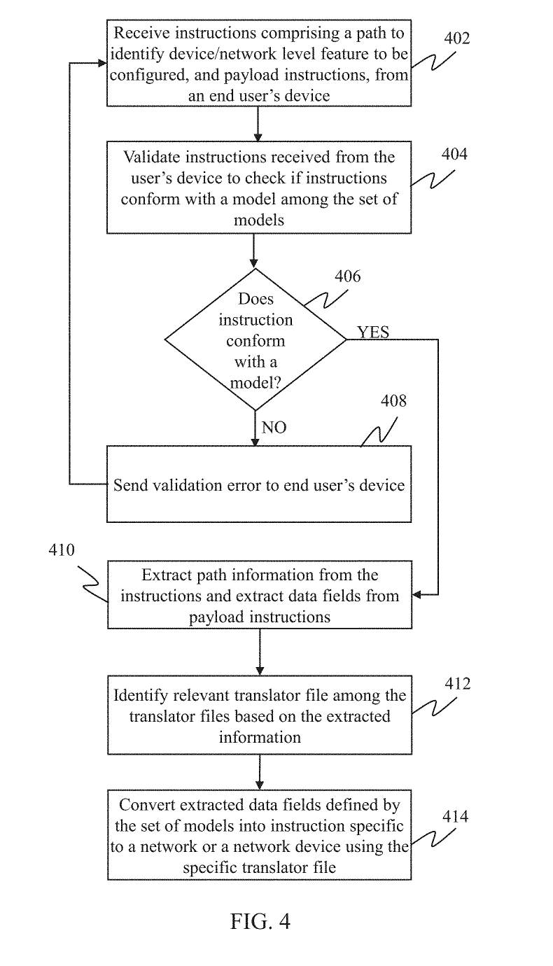

Referring to FIG. 4, a flowchart illustrates a method of converting instructions based on a standardized model into device specific instructions, in accordance with an embodiment. At step 402, the processor 103 receives instructions comprising a path to identify device/network level feature to be configured. Path identifies the relevant model among the set of models to which the instructions conform. Further, the path may include an identifier that identifies the category and the type of device that is to be configured. Category of device includes devices with various configurable features and type of device includes device from different manufacturing entities. At step 402, processor 103 may further receive payload instructions. Payload instructions includes information regarding how a feature may have to be configured using information included in the payload instructions. Instruction may be received from the user's device 200. At step 404, processor 103 may validate the instructions received from the user's device 200. Validating instructions may include checking if the instructions conform with a model among the set of models 102. At step 406, the processor 103 checks whether the instructions conform with a model. If it is determined that the instructions do not conform with a model, then at step 408, the processor 103 may send a validation error to user's device 200. If it is determined that the instructions conform with a model, then at step 410, the processor 103 may parse or extract the instructions corresponding to a path and an identifier and extract data fields from the payload instructions. At step 412, the processor 103 identifies the relevant translator file(s) among the translator files based on the parsed instruction (path and identifier). At step 414, the processor executes the identified translator file to convert instructions defined as per the set of models 102 into instructions specific to a network or a network device. The translator file may use the data fields extracted from the instructions to generate instructions specific to a network or a network device.

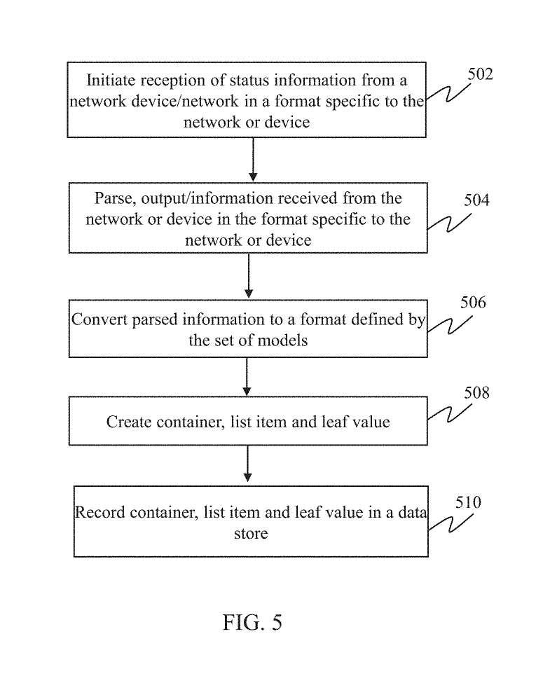

Referring to FIG. 5, a flowchart illustrates a method for converting status information corresponding to the feature of a network or a network device, to a standardized format, as defined by the YANG model. At step 502, a translator files 104 initiates reception of status information from a network device/network in a format specific to the network or device. At step 504, translator files 104 parses output/information received from the network or device in the format specific to the network or device. At step 506, the parsed information is converted to a format defined by the set of models 102. At step 508, the translator 104 creates containers, list items and leaf values corresponding to the feature. At step 510, the container, list item and leaf value are stored in the data store 204.

The database 100 is dynamically expandable, upon addition of models or set of models 102 and translator file or translator files 104. Models/files that are added to the set of models 102 include information corresponding to configurable features of network devices or networks. Translator files 104 may be added to the database 100. Each added translator file corresponds to each added and/or updated model relating to configurable feature corresponding to the network devices or networks. The database 100 may be expanded during system run time. In other words, additional information may be added to the set of models 102 and translator files 104 during system run time.

In an embodiment, parent translator files may be files that correspond to one common configurable feature in the same categories of devices (configurable features) within multiple network devices of the same type. The system may include multiple parent translator files for the same category of devices but belonging to different entities. The system further enables defining child translator files corresponding to one or more features. Child translator files may be files which inherit the common configurable features in the same categories of devices within multiple network devices of the same type from the parent translator files. For example, if A is a parent translator file and B is a child translator file, then B inherits one or more configurable features defined in A. However, not all translator files corresponding to features may be inherited from a parent file to a child file. The system further allows for explicitly excluding one or more translator files corresponding to one or more configurable features from being inherited from a parent translator file to a child translator file.

### VIII. Conclusion

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for configuring network devices, the system comprising:
a database comprising:
a set of models, representing plurality of network level or device level features as per YANG model, wherein one model corresponds to one device or network level feature in a way agnostic to the device manufacturer or device families; and
a plurality of translator files configured to convert an instruction, as represented by the set of models, into network or device specific instructions in a second format.

2. The system of claim 1, further comprising a processor configured to:
validate instructions, received in a format as defined by the YANG model, as conforming to at least one model among the set of models;
parse data corresponding to a path included in the instructions to identify a relevant translator file, wherein the identified translator file is used to convert the instructions in the format as per YANG model into device specific instructions;
parse data corresponding to an identifier that identifies the type of network device or network or category of the network device or network; and
extract data fields from payload instructions corresponding to configurable features of the network device or the network, wherein the payload instructions provide information regarding how the feature is to be configured.

3. The system of claim 2, wherein the processor executes the identified translator file to convert extracted data fields included in the payload information into device specific instructions in the second format.

4. The system of claim 2, wherein the processor executes a translator file to:
initiate reception of status information in the second format specific to the network or the network device;
parse output received in the format specific to the network device or the network;
convert the status information from the format specific to the network device or the network to a format defined by the set of models; and
record the parsed information in a data store as per relevant model.

5. The system of claim 1, configured to receive the instructions from a user's device, wherein the user's device provides instructions attempting to configure the network device level feature or the network level feature, wherein the instructions conform to at least one YANG model among the set of data models.

6. The system of claim 1, wherein, the system enables the database to be expanded dynamically upon addition of models including information corresponding to configurable features of new network devices or networks and translator files corresponding to each configurable feature.

7. The system of claim 1, wherein the database further comprises one or more parent translator files corresponding to at least one configurable feature within multiple network devices, wherein the network devices relate to network devices of same type and different category.

8. The system of claim 7, wherein the system is configured to:
enable defining child translator files, wherein the child translator files inherit one or more configurable features defined by the parent translator files; and
enable exclusion of one or more translator files corresponding to one or more configurable features from being inherited from a parent translator file to a child translator file.
